(19) United States
(12) Patent Application Publication
(10) Pub. No.: US 2026/0336812 A1
(43) Pub. Date: Oct. 29, 2026

(54) Aircraft Protection Device

(71) Applicant: Qasim Mushtaq Salman Al-Ameri, Sterling Heights, MI (US)

(72) Inventor: Qasim Mushtaq Salman Al-Ameri, Sterling Heights, MI (US)

(21) Appl. No.: 19/190,120

(22) Filed: Apr. 25, 2025

(51) Int. Cl. B64D 17/80; B64D 25/00

(52) U.S. Cl. CPC B64D 17/80; B64D 25/00; B64D 2201/00

(57) ABSTRACT

An aircraft protection device for minimizing impact force and providing floatation for an aircraft fuselage in the event of an emergency includes an aircraft having a fuselage. Each of a pair of chute compartments is positioned on an upper surface of the fuselage. Parachutes are packed into respective ones of the chute compartments and are deployable for facilitating slowing of descent of the aircraft in the event of engine failure. A belly compartment extends along a lower surface of the fuselage. A floatation bladder is packed into the belly compartment and is deployable to extend below the fuselage for providing buoyancy to the fuselage when the aircraft lands in a body of water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to aircraft protection devices and more particularly pertains to a new aircraft protection device for minimizing impact force and providing floatation for an aircraft fuselage in the event of a mid air emergency.

### (2) Description of Related Art including information disclosed under 37 CFR 1.97 and 1.98.

The prior art relates to aircraft protection devices. Known prior art lacks a combination of deployable parachutes and a floatation bladder to protect a fuselage of an aircraft in an emergency such as loss of engine power.

### BRIEF SUMMARY OF THE INVENTION

An embodiment of the disclosure meets the needs presented above by generally comprising an aircraft having a fuselage. Each of a pair of chute compartments is positioned on an upper surface of the fuselage. Parachutes are packed into respective ones of the chute compartments and are deployable for facilitating slowing of descent of the aircraft in the event of engine failure. A belly compartment extends along a lower surface of the fuselage. A floatation bladder is packed into the belly compartment and is deployable to extend below the fuselage for providing buoyancy to the fuselage when the aircraft lands in a body of water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of an aircraft protection device according to an embodiment of the disclosure.

FIG. 2 is a side view of an embodiment of the disclosure.

FIG. 3 is a top view of an embodiment of the disclosure.

FIG. 4 is a bottom view of an embodiment of the disclosure.

FIG. 5 is a partial cut-away side view of an embodiment of the disclosure.

### DETAILED DESCRIPTION OF THE INVENTION

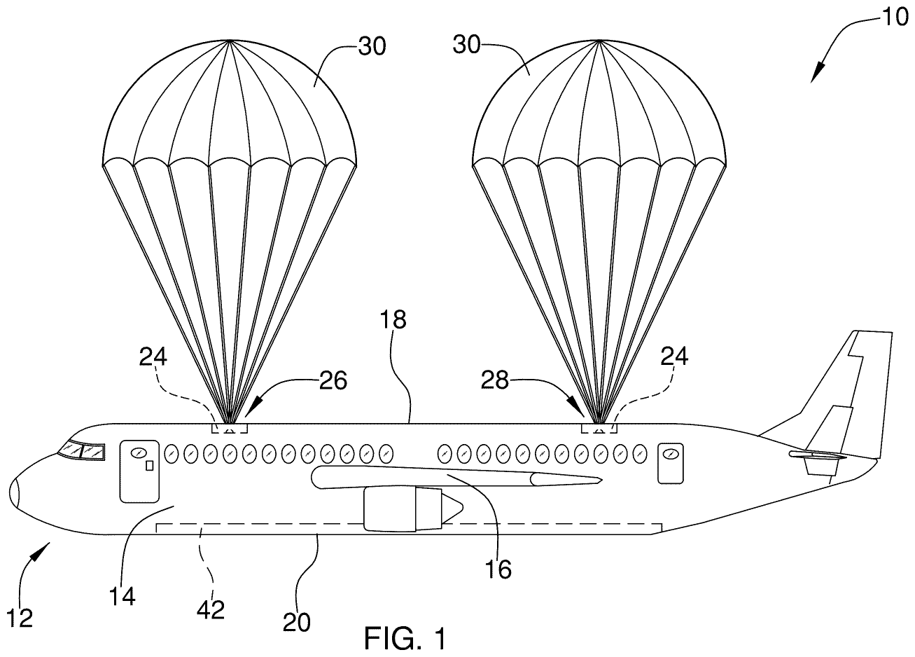

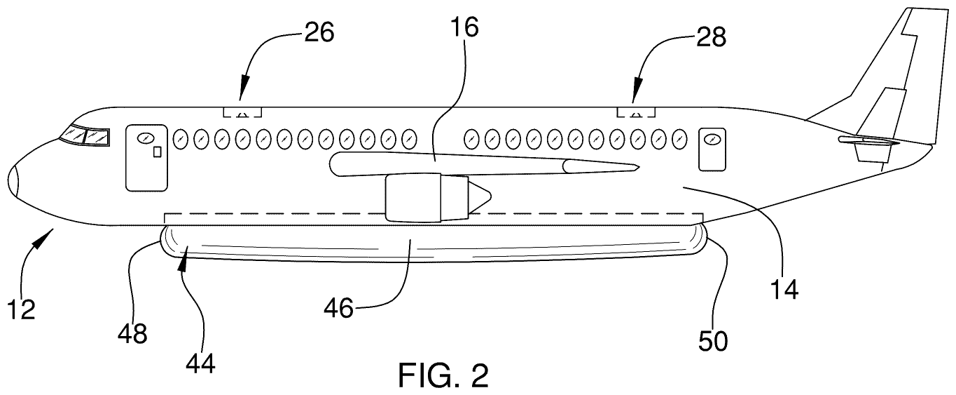

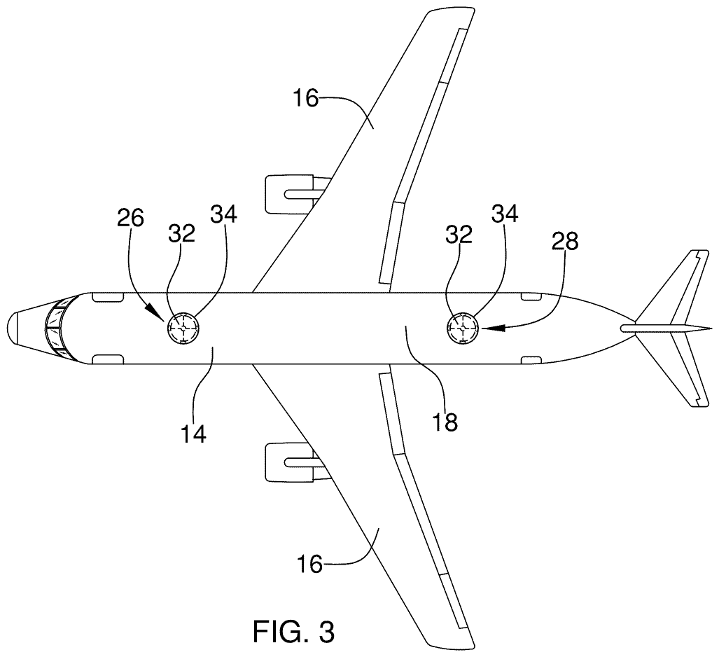

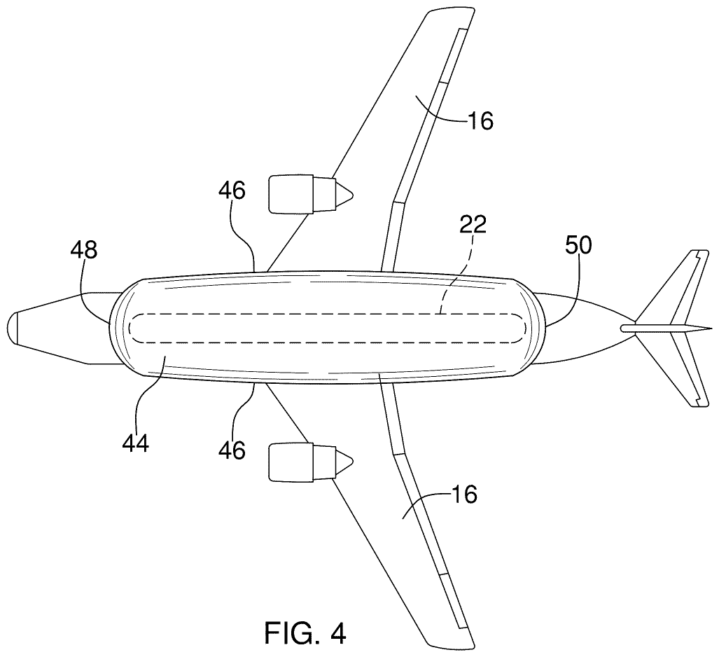

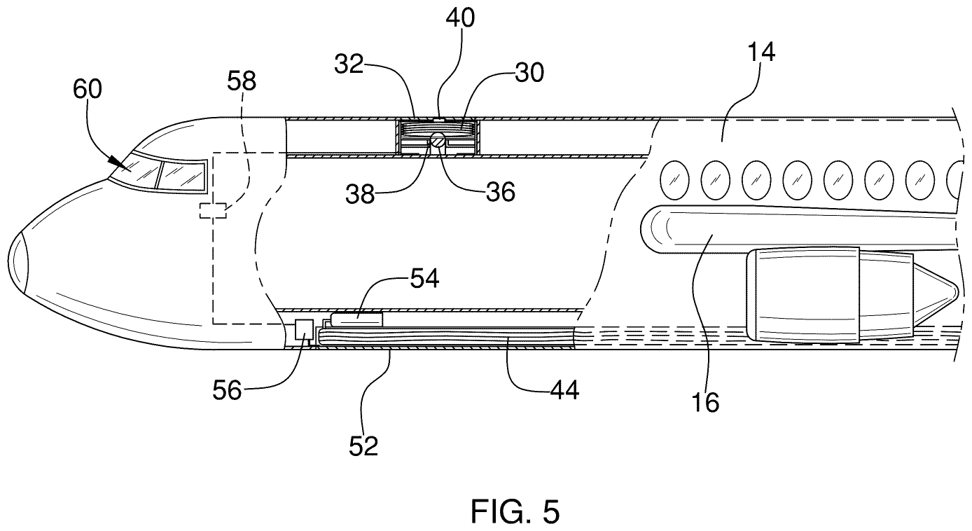

With reference now to the drawings, and in particular to FIGS. 1 through 5 thereof, a new aircraft protection device embodying the principles and concepts of an embodiment of the disclosure and generally designated by the reference numeral 10 will be described.

As best illustrated in FIGS. 1 through 5, the aircraft protection device 10 generally comprises an aircraft 12 having a fuselage 14 and a pair of wings 16 coupled to and extending outwardly from the fuselage 14. The fuselage 14 has an upper surface 18 and a lower surface 20. The fuselage 14 also has an obround opening 22 in the lower surface 20 of the fuselage 14. The obround opening 22 is generally centered along a longitudinal axis of the fuselage 14. Each of a pair of chute compartments 24 is positioned in the fuselage 14. Each chute compartment 24 is positioned on the upper surface 18 of the fuselage 14. The pair of chute compartments 24 includes a forward chute compartment 26 and an aft chute compartment 28. The pair of wings 16 is positioned between the forward chute compartment 26 and the aft chute compartment 28. Each of a pair of parachutes 30 is packed into a respective one of the chute compartments 24. Each of the parachutes 30 is deployable from the respective one of the chute compartments 24 such that the pair of parachutes 30 is configured for facilitating slowing of descent of the aircraft 12 in the event of engine failure.

Each of a pair of chute hatches 32 is coupled to the fuselage 14 and covers a respective one of the pair of chute compartments 24. Each chute hatch 32 has a circular outer peripheral edge 34. Each of a pair of chute anchors 36 is coupled to the fuselage 14 and positioned in a respective one of the chute compartments 24. Each parachute 30 has a base end 38 coupled to the chute anchor 36 positioned in the respective one of the chute compartments 24.

The device 10 further includes each of a pair of chute hatch release triggers 40. Each chute hatch release trigger 40 is positioned in a respective one of the chute compartments 24 and is operationally coupled to a respective one of the chute hatches 32 in a conventional manner for releasing the respective one of the chute hatches 32 from the fuselage 14 to expose the respective one of the chute compartments 24.

A belly compartment 42 is in the fuselage 14. The belly compartment 42 extends along the lower surface 20 of the fuselage 14. The obround opening 22 is aligned with the belly compartment 42. A floatation bladder 44 is packed into the belly compartment 42 in a uninflated condition. The floatation bladder 44 is deployable from the belly compartment 42 such that the floatation bladder is inflated and extends below the fuselage 14. Thus, the floatation bladder 44 is configured for providing buoyancy to the fuselage 14 when the aircraft 12 lands in a body of water or may provide cushioning of the fuselage 14 upon impact when landing on the floatation bladder 44. The floatation bladder 44 has an inflated width greater than a width of the fuselage 14. The floatation bladder 44 has lateral sides 46 extending between a front end 48 of the floatation bladder 44 and a rear end 50 of the floatation bladder 44. The lateral sides 46 are arcuate such that each lateral side 46 of the floatation bladder 44 is convex.

A belly cover 52 is coupled to and extends over the obround opening 22 in a conventional manner. The belly cover 52 is releasable from the fuselage 14 for exposing the belly compartment 42 for release of the floatation bladder 44 through the obround opening 22. A compressed gas tank 54 is positioned within the belly compartment 42 adjacent to the floatation bladder 44. The compressed gas tank 54 is in fluid communication with the floatation bladder 44 such that the compressed gas tank 54 is configured for inflating the floatation bladder 44. A belly cover release trigger 56 is positioned within the belly compartment42. The belly cover release trigger 56 is operationally coupled to the belly cover 52 for releasing the belly cover 52 from the fuselage 14 to expose the obround opening 22.

A control unit 58 is positioned within a cockpit 60 of the aircraft 12. The control unit 58 may be a computer, button, or similar device in electrical communication for remotely actuating the belly cover release trigger 56 from the cockpit 60. Similarly, the control unit 60 is in electrical communication for remotely actuating each of the chute hatch release triggers 40 from the cockpit 60.

In use, a pilot in the cockpit 60 can selectively release the parachutes 30 and the floatation bladder 44. The parachutes 30 and floatation bladder 44 may be released simultaneously or independently from each other.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An aircraft protection device comprising:
an aircraft having a fuselage, said fuselage having an upper surface and a lower surface;
a pair of chute compartments in said fuselage, each chute compartment being positioned on said upper surface of said fuselage;
a pair of parachutes, each parachute being packed into a respective one of said chute compartments, each of said parachutes being deployable from said respective one of said chute compartments wherein said pair of parachutes is configured for facilitating slowing of descent of the aircraft in the event of engine failure;
a belly compartment in said fuselage, said belly compartment extending along said lower surface of said fuselage; and
a floatation bladder packed into said belly compartment, said floatation bladder being deployable from said belly compartment wherein said floatation bladder extends below said fuselage and is configured for providing buoyancy to said fuselage when said aircraft lands in a body of water, said floatation bladder having an inflated width greater than a width of said fuselage at opposed ends of an opening in said fuselage to said belly compartment.

2. The aircraft protection device of claim 1, further comprising said aircraft having a pair of wings coupled to and extending outwardly from said fuselage, pair of chute compartments including a forward chute compartment and an aft chute compartment, said pair of wings being positioned between said forward chute compartment and said aft chute compartment.

3. The aircraft protection device of claim 2, further comprising a pair of chute hatches, each chute hatch covering a respective one of said pair of chute compartments.

4. The aircraft protection device of claim 3, further comprising each chute hatch having a circular outer peripheral edge.

5. The aircraft protection device of claim 1, further comprising a pair of chute anchors, each chute anchor being coupled to said fuselage and positioned in a respective one of said chute compartments, each parachute having a base end coupled to said chute anchor positioned in said respective one of said chute compartments.

6. The aircraft protection device of claim 1, further comprising:
said opening being obround and in said lower surface of said fuselage, said obround opening being aligned with said belly compartment; and
a belly cover coupled to and extending over said opening, said belly cover being releasable from said fuselage for exposing said belly compartment for release of said floatation bladder through said opening.

7. The aircraft protection device of claim 6, further comprising a compressed gas tank positioned within said belly compartment, said compressed gas tank being in fluid communication with said floatation bladder wherein said compressed gas tank is configured for inflating said floatation bladder.

8. (canceled)

9. The aircraft protection device of claim 1, further comprising said floatation bladder having lateral side extending between a front end of said floatation bladder and a rear end of said floatation bladder, said lateral sides being arcuate such that each lateral side of said floatation bladder is convex.

10. The aircraft protection device of claim 6, further comprising:
a belly cover release trigger mechanism positioned within said belly compartment, said belly cover release triggers being operationally coupled to said belly cover for releasing said belly cover from said fuselage to expose said opening; and
a control unit positioned within a cockpit of said aircraft, said control unit being in electrical communication for remotely actuating said belly cover release trigger from said cockpit.

11. The aircraft protection device of claim 3, further comprising a pair of chute hatch release triggers, each chute hatch release trigger being positioned in a respective one of said chute compartments, each said chute hatch release trigger being operationally coupled to a respective one of said chute hatches for releasing said respective one of said chute hatches from said fuselage to expose said respective one of said chute compartments.

12. The aircraft protection device of claim 11, further comprising a control unit positioned within a cockpit of said aircraft, said control unit being in electrical communication for remotely actuating each of said chute hatch release triggers from said cockpit.

13. An aircraft protection device comprising:
an aircraft having a fuselage and a pair of wings coupled to and extending outwardly from said fuselage, said fuselage having an upper surface and a lower surface, said fuselage having an obround opening in said lower surface of said fuselage;
a pair of chute compartments in said fuselage, each chute compartment being positioned on said upper surface of said fuselage, said pair of chute compartments including a forward chute compartment and an aft chute compartment, said pair of wings being positioned between said forward chute compartment and said aft chute compartment;
a pair of parachutes, each parachute being packed into a respective one of said chute compartments, each of said parachutes being deployable from said respective one of said chute compartments wherein said pair of parachutes is configured for facilitating slowing of descent of the aircraft in the event of engine failure;
a pair of chute hatches, each chute hatch covering a respective one of said pair of chute compartments, each chute hatch having a circular outer peripheral edge;
a pair of chute anchors, each chute anchor being coupled to said fuselage and positioned in a respective one of said chute compartments, each parachute having a base end coupled to said chute anchor positioned in said respective one of said chute compartments;
a pair of chute hatch release triggers, each chute hatch release trigger being positioned in a respective one of said chute compartments, each said chute hatch release trigger being operationally coupled to a respective one of said chute hatches for releasing said respective one of said chute hatches from said fuselage to expose said respective one of said chute compartments;
a belly compartment in said fuselage, said belly compartment extending along said lower surface of said fuselage, said obround opening being aligned with said belly compartment; and
a floatation bladder packed into said belly compartment, said floatation bladder being deployable from said belly compartment wherein said floatation bladder extends below said fuselage and is configured for providing buoyancy to said fuselage when said aircraft lands in a body of water, said floatation bladder having an inflated width greater than a width of said fuselage at opposed ends of said obround opening in said fuselage to said belly compartment, said floatation bladder having lateral side extending between a front end of said floatation bladder and a rear end of said floatation bladder, said lateral sides being arcuate such that each lateral side of said floatation bladder is convex;
a belly cover coupled to and extending over said obround opening, said belly cover being releasable from said fuselage for exposing said belly compartment for release of said floatation bladder through said obround opening;
a compressed gas tank positioned within said belly compartment, said compressed gas tank being in fluid communication with said floatation bladder wherein said compressed gas tank is configured for inflating said floatation bladder;
a belly cover release trigger mechanism positioned within said belly compartment, said belly cover release triggers being operationally coupled to said belly cover for releasing said belly cover from said fuselage to expose said obround opening; and
a control unit positioned within a cockpit of said aircraft, said control unit being in electrical communication for remotely actuating said belly cover release trigger from said cockpit, said control unit being in electrical communication for remotely actuating each of said chute hatch release triggers from said cockpit.
